(19) United States
(12) Patent Application Publication
(10) Pub. No.: US 2020/0182701 A1
(43) Pub. Date: Jun. 11, 2020

(54) APPARATUS FOR MEASURE OF COHERENCE OF LIGHT SOURCE FOR HOLOGRAPHIC DISPLAY AND METHOD THEREOF

(71) Applicant: ELECTRONICS AND TELECOMMUNICATIONS RESEARCH INSTITUTE, Daejeon (KR)

(72) Inventors: Jeho NAM, Daejeon (KR); Min-Sik PARK, Sejong (KR); Seung Hyup SHIN, Daejeon (KR)

(21) Appl. No.: 16/552,940

(22) Filed: Aug. 27, 2019

(30) Foreign Application Priority Data
Dec. 5, 2018 (KR) 10-2018-0155561

(51) Int. Cl. G01J 9/02

(52) U.S. Cl. CPC G01J 9/0215; G01J 2009/0211; G01J 2009/0238

(57) ABSTRACT

A method and an apparatus for measuring a coherence of a light source of a holographic display through steps of: photographing an interference pattern generated by light output from the light source; obtaining an interference pattern feature information with respect to the interference pattern from an interference pattern image of the interference pattern; and measuring the coherence of the light source based on the interference pattern feature information, are provided.

### CROSS-REFERENCE TO RELATED APPLICATION

This application claims priority to and the benefit of Korean Patent Application No. 10-2018-0155561 filed in the Korean Intellectual Property Office on Dec. 5, 2018, the entire contents of which are incorporated herein by reference.

### BACKGROUND OF THE INVENTION

### (a) Field of the Invention

The present invention relates to an apparatus and a method for evaluating coherence indicating interference capability of a light source of a holographic display.

### (b) Description of the Related Art

A holography technique is an ultimate 3D image reconstruction technique that can overcome limitations of representation such as vergence-accommodation conflict caused by a stereo method according to the conventional art, by reproducing a 3D object in space and providing a natural three-dimensional effect to a viewer.

In particular, the digital holography technique may reproduce stereoscopic images as if they were in space by an optical display method for 3D information related to 3D objects and real images based on a principle of optical diffraction and interference by using a photo-electronic device and a computer.

### SUMMARY OF THE INVENTION

The present invention has been made in an effort to provide a technique for objectively evaluating optical characteristic elements for improving coherence of a light source by means of a more systematic method than a conventional art in order to improve the quality of a reproduced holographic image.

An exemplary embodiment provides an apparatus for measuring a coherence of a light source of a holographic display, the apparatus comprising: an image measurement unit configured to photograph an interference pattern generated by light output from the light source; a feature information extractor configured to obtain an interference pattern feature information with respect to the interference pattern from an interference pattern image of the interference pattern; and a coherence measurement unit configured to measure the coherence of the light source based on the interference pattern feature information.

The interference pattern feature information may be an average of all brightness values on a straight line parallel to a vertical axis of the interference pattern image when the interference pattern is in a vertical direction.

The interference pattern feature information may be an average of all brightness values on a straight line parallel to a horizontal axis of the interference pattern image when the interference pattern is in a horizontal direction.

The coherence measurement unit may be further configured to calculate a contrast of the interference pattern feature information and determine a rotation angle of the interference pattern which maximizes the contrast.

The contrast may be calculated by dividing a difference between a maximum value of the interference pattern feature information and a minimum value of the interference pattern feature information by a sum of the maximum value and the minimum value.

The apparatus may further include an analyzing processor configured to analyze influence of characteristic information of components of the light source on the coherence by using a neural network based on the rotation angle.

The light source may include a spatial filter and a collimator; and the characteristic information may include at least one of a lens focal distance of the spatial filter, a lens focal distance of the collimator, a size of an opening of the light source or a pin hole, a diameter of a collimating lens, a diameter of aspheric lens, and a degree of alignment of incident light.

When the analyzing processor analyzes the influence of the interference pattern feature information, the analyzing processor may perform machine learning by using the neural network based on a training set including the characteristic information of the light source mapped to interference pattern feature information having a high contrast.

The analyzing processor may be further configured to feedback an optimal characteristic value for the light source determined by a result of the machine learning through the neural network.

The apparatus may further include a shear interferometer configured to receive the light and represent a degree of the coherence of the light source through the interference pattern, wherein when the image measurement unit photographs the interference pattern, the image measurement unit may photograph the interference pattern represented on the shear interferometer.

Another exemplary embodiment provides a method for measuring a coherence of a light source of a holographic display, the method comprising: photographing an interference pattern generated by light output from the light source; obtaining an interference pattern feature information with respect to the interference pattern from an interference pattern image of the interference pattern; and measuring the coherence of the light source based on the interference pattern feature information.

The interference pattern feature information may be an average of all brightness values on a straight line parallel to a vertical axis of the interference pattern image when the interference pattern is in a vertical direction.

The interference pattern feature information may be an average of all brightness values on a straight line parallel to a horizontal axis of the interference pattern image when the interference pattern is in a horizontal direction.

The measuring the coherence of the light source based on the interference pattern feature information may include: calculating a contrast of the interference pattern feature information; and determining a rotation angle of the interference pattern which maximizes the contrast.

The contrast may be calculated by dividing a difference between a maximum value of the interference pattern feature information and a minimum value of the interference pattern feature information by a sum of the maximum value and the minimum value.

The method may further include analyzing influence of characteristic information of components of the light source on the coherence by using a neural network based on the rotation angle.

The light source may include a spatial filter and a collimator; and the characteristic information may include at least one of a lens focal distance of the spatial filter, a lens focal distance of the collimator, a size of an aperture of the light source or a pin hole, a diameter of a collimating lens, a diameter of aspheric lens, and a degree of alignment of incident light.

The analyzing influence of characteristic information of components of the light source on the coherence by using a neural network based on the rotation angle may include performing machine learning by using the neural network based on a training set including the characteristic information of the light source mapped to interference pattern feature information having a high contrast.

The method may further include feeding-back an optimal characteristic value for the light source determined by a result of the machine learning through the neural network.

Yet another exemplary embodiment provides an apparatus for measuring coherence for holographic display, the apparatus comprising: a light source configured to output a plane wave having the coherence; a camera configured to photograph an interference pattern by the plane wave; and a processor configured to obtain an interference pattern feature information with respect to the interference pattern from an interference pattern image which is photographed by the camera and measure the coherence of the light source based on the interference pattern feature information.

### BRIEF DESCRIPTION OF THE DRAWINGS

FIG. 1 illustrates a coherence evaluating apparatus according to an exemplary embodiment.

FIG. 2 illustrates a coherence measurement apparatus according to an exemplary embodiment.

FIG. 3 illustrates a coherence measurement apparatus according to an exemplary embodiment.

FIG. 4A to FIG. 4C illustrate various interference pattern images according to an exemplary embodiment.

FIG. 5 illustrates a light source according to an exemplary embodiment.

FIG. 6 illustrates interference pattern image and the interference pattern feature information according to an exemplary embodiment.

FIG. 7 illustrates a light source according to an exemplary embodiment.

FIG. 8 illustrates a flowchart showing a coherence measuring method according to an exemplary embodiment.

FIG. 9 is a block diagram illustrating a coherence measurement apparatus according to another exemplary embodiment.

### DETAILED DESCRIPTION OF THE EMBODIMENTS

In the following detailed description, only certain exemplary embodiments have been shown and described, simply by way of illustration. As those skilled in the art would realize, the described embodiments may be modified in various different ways, all without departing from the spirit or scope. Accordingly, the drawings and description are to be regarded as illustrative in nature and not restrictive. Like reference numerals designate like elements throughout the specification.

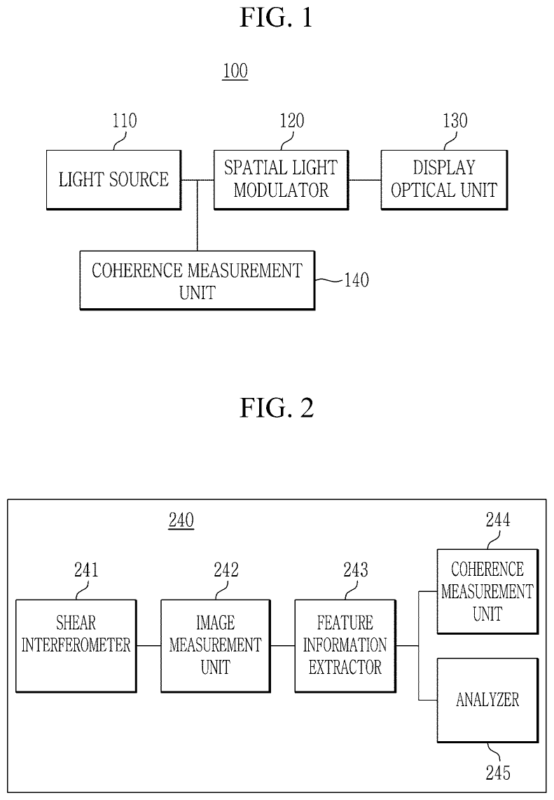

FIG. 1 illustrates a coherence evaluating apparatus according to an exemplary embodiment.

As illustrated in FIG. 1, according to the present exemplary embodiment, a coherence evaluating apparatus 100 includes a light source 110, a spatial light modulator 120, a display optical unit 130, and a coherence measurement and evaluation unit 140.

The light source 110 outputs light of a collimated plane wave. A light source having coherence is necessarily required in order to optically reconstruct a hologram. A diode pumped solid state (DPSS) laser is widely used as a representative coherent light source of a holographic display.

High coherence of the laser light source provides the quality of reproduced holographic images based on clear and stable coherency. However, there is a problem involving speckle noise, and there is a problem that may cause visual damage due to the laser depending on a wavelength and output intensity exposed to the user.

A laser diode (LD) and a LED light source may be used for optical reconstruction of the holographic display in addition to a laser. In particular, the LED may include another type of LED having a wide wavelength range and high output, such as an mLED (micro LED) and an sLED (super-luminescent LED).

The coherence, which is an indicator of interference capability of the light source, is classified into ‘temporal coherence’ and ‘spatial coherence’.

As a wavelength spectrum is narrower, the temporal coherence of the light source becomes higher, and a coherence length at which the coherence is ensured is also increased. However, the speckle noise increases as temporal interference increases, and thus image quality of a reproduced holographic image gradually deteriorates.

On the other hand, performance of the spatial coherence is determined in a collimating process that produces a plane wave that is necessary for reconstructing the holographic image. Particularly, the spatial coherence is very important to obtain clear and sharp image quality of the reconstructed holographic image.

However, a representative conventional method for evaluating the coherence of the light source of the holographic display is a method of simply observing an interference pattern of a shearing interferometer with the naked eye, which is disadvantageous in that it is difficult to accurately evaluate a degree of coherence.

An apparatus and a method for measuring coherence of the light source of the holographic display according to an exemplary embodiment is a new invention for measuring coherence. The coherence measuring apparatus may quantitatively calculate the degree of the coherence of the light source of the holographic display to be easily quantified by automatically measuring and analyzing the interference pattern of the shearing interferometer. Further, the coherence measuring apparatus may finally improve the quality of the holographic image reproduced by the holographic display by analyzing optical elements that affect a coherence characteristic.

The spatial light modulator 120 receives light that is a plane wave outputted from the light source 110, modulates the light, and transfers the modulated light to the display optical unit 130.

The display optical unit 130 displays a hologram in a 3D space by using the modulated light.

The coherence measurement and evaluation unit 140 measures a coherence characteristic of the light source 110 and evaluates the coherence characteristic.

FIG. 2 illustrates a coherence measurement apparatus according to an exemplary embodiment.

As illustrated in FIG. 2, according to the present exemplary embodiment, a coherence measurement apparatus 240 includes a shear interferometer 241, an image measurement unit 242, a feature information extractor 243, a coherence measurement unit 244, and an analyzer 245.

The coherence measurement apparatus 240 may be configured as at least one processor for performing operations to be described below.

The shear interferometer 241 receives light that is a plane wave output from the light source. The shear interferometer 241 generates an interference pattern (or fringe) by reflecting the received light.

The image measurement unit 242 photographs the interference pattern represented by the shear interferometer 241 to obtain an interference pattern image. The image measurement unit 242 includes a CCD image sensor or a DSLR camera, and acquires an interference pattern image by using the CCD image sensor or the DSLR camera.

The feature information extractor 243 extracts interference pattern feature information related to the interference pattern from the interference pattern image obtained by the image measurement unit 242. The interference pattern feature information may be used for measuring, analyzing, or evaluating a coherence characteristic of the light source. The interference pattern image may be represented as I(m,n). Herein, m indicates a horizontal axis (x-axis) coordinate, and n indicates a vertical axis (y-axis) coordinate. In addition, I(m,n) indicates the brightness of the interference pattern image at the point (m,n).

The feature information S(m) extracted by the feature information extractor 243 is information with respect to the brightness of the interference pattern image and may be defined as below. The interference pattern feature information S(m) is an average of all brightness values on a straight line x=m parallel to the vertical axis. The interference pattern feature information S(m) is the average of all brightness values on the straight line parallel to the vertical axis because the interference pattern is mainly in the vertical direction. When the interference pattern is mainly in the horizontal direction, the interference pattern feature information S(m) may be an average of all brightness values on the straight line y=n parallel to the horizontal axis. The interference pattern feature information S(m) of the interference pattern image extracted by the feature information extractor 243 may be represented by using the following

$$Equation 1.$$

$$S ( m ) = \frac{1}{N} {\sum }_{n = 0}^{N - 1} I ( m , n ) \qquad ( Equation 1 )$$

In the Equation 1, a minimum value of n is 0, and N is a maximum value of n.

The coherence measurement unit 244 may utilize a contrast C of the interference pattern feature information S(m) to quantitatively evaluate the degree of the coherence of the light source. The contrast C of the interference pattern feature information S(m) may be a value indicating the degree of the coherence of the light source quantitatively. The coherence measurement unit 244 may evaluate the degree of the coherence of the light source (e.g., the light source 110 in FIG. 1) based on the interference pattern feature information extracted by the feature information extractor 243. The coherence measurement unit 244 may determine the contrast C of the interference pattern feature information by using the following Equation 2.

$$C = \frac{{S}_{max} ( {m}_{1} ) - {S}_{min} ( {m}_{2} )}{{S}_{max} ( {m}_{1} ) + {S}_{min} ( {m}_{2} )} \qquad ( Equation 2 )$$

In Equation 2, S(m) becomes maximum Sₘₐₓ(m₁) at one point m₁ of the interference pattern image, and S(m) becomes minimum Sₘᵢₙ(m₂) at another point m₂.

Referring to Equation 2, the contrast C of the interference pattern feature information S(m) is larger as the difference between the bright portions and the dark portions of the interference pattern image is large, and at this time, the coherence of the light source may be evaluated as high. In other words, the higher the coherence or the partial coherence of the light source, the higher the contrast between the bright portions and the dark portions of the interference pattern indicated by the shear interferometer, and the contrast C becomes higher.

The analyzer 245 analyzes characteristic information of components included in the light source which affect the coherence by using a machine learning scheme. According to an exemplary embodiment, the analyzer 245 may classify the optical components that affect the coherence characteristics of the light source among components of the light source based on the angle of maximizing the contrast of the interference pattern feature information, and may determine an optimal characteristic value for the component of the light source according to the classification result of the optical component.

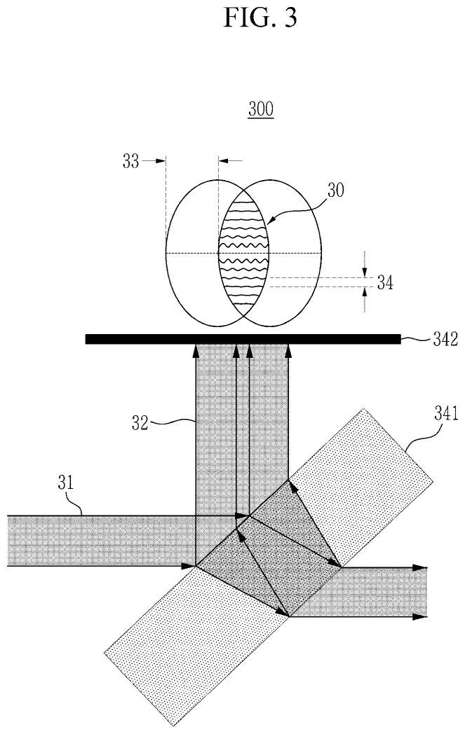

FIG. 3 illustrates a coherence measurement apparatus according to an exemplary embodiment.

As illustrated in FIG. 3, according to an exemplary embodiment, a coherence measurement apparatus 300 includes a shear interferometer 341 and an image measurement unit 342.

The shear interferometer 341 receives light 31 as a plane wave from the light source (e.g., the light source 110 in FIG. 1). The light 31 may arrive at the shear interferometer 341 at an incidence angle of 45 degrees, but the present invention is not limited thereto.

The shear interferometer 341 refracts the received light 31. In addition, the shear interferometer 341 reflects the received light 31 at an angle of 45 degrees, which is the same angle as the incidence angle. The shear interferometer 341 generates a path difference in the light 31 while reflecting the light 31.

The light 32 reflected by the shear interferometer 341 is transferred to the image measurement unit 342. A wavefront of the reflected light 32 crosses that of the received light 31 while being overlapped therewith. A fringe or an interference pattern 30 may be generated as the wavefront of the reflected light 32 and the wavefront of the received light 31 are overlapped with each other.

The image measurement unit 342 photographs the interference pattern 30 represented by the shear interferometer 341 to obtain an interference pattern image of the interference pattern 30.

The interference pattern 30 may be a pattern formed with constant fringe spacing 34. The interference pattern 30 is formed between shear distances 33 in the interference pattern image.

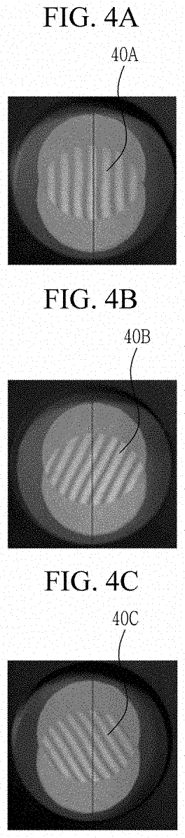

FIG. 4A to FIG. 4C illustrate various interference pattern images according to an exemplary embodiment.

Referring to FIG. 4A, when the coherence of the light source has a maximum value (i.e., the light of the light source is an ideal plane wave), interference patterns (or fringes) with the same interval spacing appear evenly parallel with the vertical axis.

However, Referring to FIG. 4B or FIG. 4C, when the coherence has a value between the maximum value and a minimum value (when the collimating is not complete), the incident light diverges (FIG. 4B) or converges (FIG. 4C). When the incident light diverges or converges, the interference pattern (or fringe) may be inclined at a certain angle from the vertical axis.

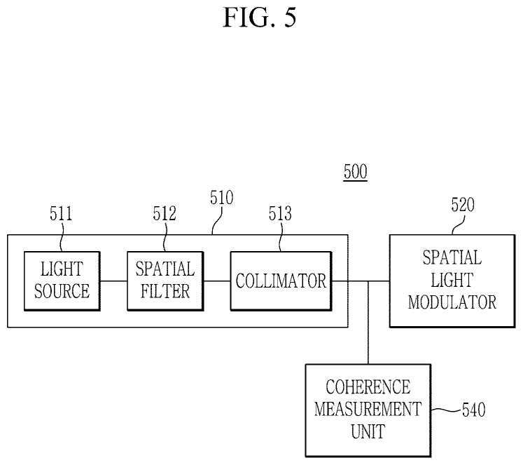

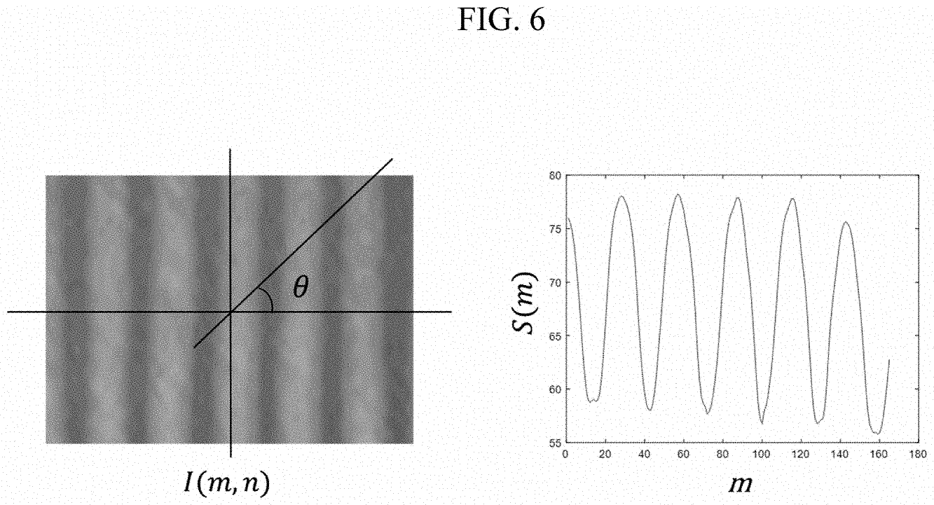

FIG. 5 illustrates a light source according to an exemplary embodiment, and FIG. 6 illustrates an interference pattern image and the interference pattern feature information according to an exemplary embodiment.

As illustrated in FIG. 5, according to the present exemplary embodiment, a coherence measurement apparatus 500 includes a light source 510, a spatial light modulator 520, and a coherence measurement unit 540.

The light source 510 includes a light source 511, a spatial filter 512, and a collimator 513.

The light source 511 emits light and transfers the light to the spatial filter 512. The spatial filter 512 removes a DC (direct current) component or a conjugate component of the transferred light. The light source 511 and the space filter 512 transfer the light of a certain angle to the collimator 513.

The collimator 513 is a spectroscope that splits light received from the light source disposed at a specific distance into light at infinity.

On the other hand, when a lens focal distance of the spatial filter 512, a lens focal distance of the collimator 513, and a lens incidence portion of incident light cannot pass exactly through a center, distortion occurs in a wavefront of an outputted plane wave.

When the distortion occurs in the wavefront of the outputted plane wave, the interference pattern is tilted to the left or right by an angle θ. FIG. 4B illustrates a shape in which the interference pattern is tilted to the left, and FIG. 4C illustrates a shape in which the interference pattern is tilted to the right.

Referring to FIG. 6, when the incident light converges or diverges, the interference pattern image is inclined by θ with respect to the horizontal axis or the vertical axis. The interference pattern feature information S(m,θ) is shown in Equation 3 below.

That is, the feature information extractor 243 acquires the feature information S(m, θ) by using the following Equation 3.

$$S ( m , θ ) = \frac{1}{N} {\sum }_{n = 0}^{N - 1} {R}_{θ} [ I ( m , n ) ] , {R}_{θ} [ \cdot ] = ( \begin{matrix}cos θ & - sin θ \\ sin θ & cos θ\end{matrix} ) \qquad ( Equation 3 )$$

In FIG. 3, R_{θ}[I(m, n)] indicates a rotation function (matrix) that rotates a matrix I(m,n) by an angle θ.

The coherence measurement unit 244 acquires the contrast C(θ) based on the interference pattern feature information S(m,θ) in which the distortion characteristic of the wavefront is reflected. The contrast C(θ) may be represented by using the following Equation 4.

$$C ( θ ) = \frac{{S}_{max} ( {m}_{1} , θ ) - {S}_{min} ( {m}_{2} , θ )}{{S}_{max} ( {m}_{1} , θ ) + {S}_{min} ( {m}_{2} , θ )} \qquad ( Equation 4 )$$

According to an exemplary embodiment, the coherence measurement unit 244 finds out the angle θ which maximizes the contrast C(θ)

$$( i . e . , {max}_{θ} C ( θ ) ) .$$

For example, the coherence measurement unit 244 may change the angle θ and check how the contrast C(θ) changes accordingly, and determine the angle θ when the contrast C(θ) is the maximum value.

The analyzer 245 may analyze the influence of each component of the light source 110 on the partial coherence or the coherence based on the angle that maximizes the contrast C and may determine an optimal characteristic value of each component of the light source 110.

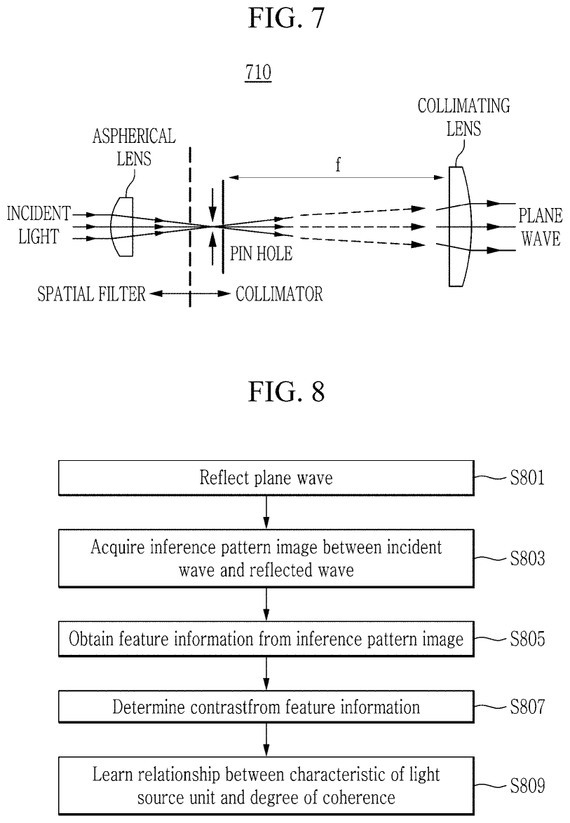

FIG. 7 illustrates a light source according to an exemplary embodiment.

As illustrated in FIG. 7, according to the present exemplary embodiment, a light source 710 includes a spatial filter and a collimator. The spatial filter is formed of an aspherical lens. The collimator is formed of a collimating lens.

The aspherical lens of the spatial filter make the incident light converged into a pin hole. The collimating lens splits the light transferred from the pin hole into a plane wave.

The coherence of the light source may be changed depending on characteristic information of the light source, such as lens focal distance f of the collimator and the spatial filter, an aperture size of the light source or the pin hole, a diameter of a collimating lens or aspherical lens, and a degree of alignment of the incident light.

According to an exemplary embodiment, the analyzer 245 may learn an influence on the partial coherence or the coherence characteristic information of the light source by the component of the light source, such as the lens focal distance f of the collimator and the spatial filter, an aperture size of the light source or the pin-hole, a diameter of the collimating lens or aspherical lens, and a degree of alignment of the incident light, in a non-linear manner, and may classify the learning result.

For example, the analyzer 245 learns the effect of the component of the light source on the partial coherence or coherence through a deep neural network (DNN) having a plurality of hidden layers. Then, the analyzer 245 may determine the optimum characteristic value of each component of the light source unit. In this case, the optimal characteristic value of each component is a value that is capable of maximizing the contrast C(θ) of the interference pattern feature information S(m,θ). The analyzer 245 may utilize the characteristic information of the component of the light source as the input data of the DNN and accordingly performs the machine learning through the DNN based on the degree of the coherence output from the DNN. Accordingly, the analyzer 245 may determine an optimal characteristic value of the component of the light source having a high coherence. The training set required for the supervised learning of the DNN may be the characteristic information of the component of the light source which mapped with the interference pattern feature information S(m,θ) having the high contrast. The DNN may be learned based on the training set composed of the characteristic information of the component of the light source having the high coherence characteristic. If the interference pattern feature information S(m,θ) indicating the distorted partial coherence or the distorted coherence is input, the corresponding distortion factor is classified according to the weight of the learned DNN, so that the coherence characteristic analysis may be performed.

The analyzer 245 may feedback the optimal characteristic value to each component of the spatial filter and the collimator of the light source 110 based on an analysis result of the coherence characteristics performed by using the learned neural network.

FIG. 8 illustrates a flowchart showing a coherence measuring method according to an exemplary embodiment.

As illustrated in FIG. 8, according to the present exemplary embodiment, the coherence measurement apparatus introduces a plane wave outputted from a light source to a shear interferometer, and reflects it by using the shear interferometer (S801).

The coherence measurement apparatus generates an interference pattern depending on overlap between the introduced wave and the reflected wave of the plane wave, and photographs the interference pattern so as to acquire an interference pattern image (S803).

The coherence measurement apparatus obtains interference pattern feature information including information related to a signal magnitude from the interference pattern image (S805).

The coherence measurement apparatus determines a contrast of the interference pattern feature information from the obtained feature information (S807).

The coherence measurement apparatus determines an angle θ which maximizes contrast of the interference pattern feature information and learns a relationship between characteristics of the optical components of the light source and the degree of the coherence based on the determined angle θ (S809).

Finally, the coherence measurement apparatus may control the optical elements of the light source (e.g., a focal length of the collimating lens) to an optimum characteristic value based on the learned result by the neural network.

According to the exemplary embodiments, coherence characteristics of the light source of the holographic display may be measured by using a photographing device instead of visual identification, thereby objectively evaluating coherence of the light source and a structure of the light source depending on the coherence.

In addition, the quality of the reproduced holographic image may be improved by evaluating optical characteristic factors for enhancing coherence through optical reconstruction of the holographic display and reflecting the results in an optical configuration of the light source.

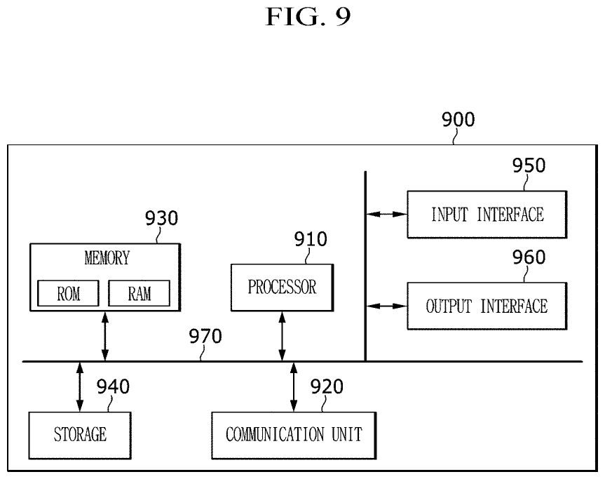

FIG. 9 is a block diagram illustrating a coherence measurement apparatus according to another exemplary embodiment.

A coherence measurement apparatus according to the current exemplary embodiment may be implemented as a computer system, e.g., a computer readable medium. Referring to FIG. 9, the computer system 900 may include at least one of a processor 910 communicating via a bus 970, a memory 930, an input interface device 950, an output interface device 960, and storage 940. The computer system 900 also may include a communication device 920 coupled to the network. The processor 910 may be a central processing unit (CPU) or a semiconductor device that executes instructions stored in the memory 930 or the storage device 940. The memory 930 and the storage device 940 may include various forms of volatile or non-volatile storage media. For example, the memory 930 may include a read only memory (ROM) and a random access memory (RAM). In the exemplary embodiments of the present disclosure, the memory may be located inside or outside the processor, and the memory may be coupled to the processor through various means that are already known.

Thus, the exemplary embodiments may be implemented as a computer-implemented method or as a non-volatile computer-readable medium having computer-executable instructions stored thereon. In an exemplary embodiment, when executed by a processor, the computer-readable instructions may perform the method according to at least one aspect of the present disclosure.

Although the embodiments of the present invention have been described in detail above, the scope of the present invention is not limited thereto, and various modifications and improvements of those skilled in the art using the basic concepts of the present invention defined in the following claims are also provided. It belongs to the scope of rights.

What is claimed is:

1. An apparatus for measuring a coherence of a light source of a holographic display, the apparatus comprising:
an image measurement unit configured to photograph an interference pattern generated by light output from the light source;
a feature information extractor configured to obtain an interference pattern feature information with respect to the interference pattern from an interference pattern image of the interference pattern; and
a coherence measurement unit configured to measure the coherence of the light source based on the interference pattern feature information.

2. The apparatus of claim 1, wherein
the interference pattern feature information is an average of all brightness values on a straight line parallel to a vertical axis of the interference pattern image when the interference pattern is in a vertical direction.

3. The apparatus of claim 1, wherein
the interference pattern feature information is an average of all brightness values on a straight line parallel to a horizontal axis of the interference pattern image when the interference pattern is in a horizontal direction.

4. The apparatus of claim 1, wherein
the coherence measurement unit is further configured to calculate a contrast of the interference pattern feature information and determine a rotation angle of the interference pattern which maximizes the contrast.

5. The apparatus of claim 4, wherein
the contrast is calculated by dividing a difference between a maximum value of the interference pattern feature information and a minimum value of the interference pattern feature information by a sum of the maximum value and the minimum value.

6. The apparatus of claim 4, further comprising
an analyzing processor configured to analyze influence of characteristic information of components of the light source on the coherence by using a neural network based on the rotation angle.

7. The apparatus of claim 6, wherein
the light source includes a spatial filter and a collimator; and
the characteristic information includes at least one of a lens focal distance of the spatial filter, a lens focal distance of the collimator, a size of an opening of the light source or a pin hole, a diameter of a collimating lens, a diameter of aspheric lens, and a degree of alignment of incident light.

8. The apparatus of claim 6, wherein when the analyzing processor analyzes the influence of the interference pattern feature information, the analyzing processor performs machine learning by using the neural network based on a training set including the characteristic information of the light source mapped to interference pattern feature information having a high contrast.

9. The apparatus of claim 8, wherein
the analyzing processor is further configured to feedback an optimal characteristic value for the light source determined by a result of the machine learning through the neural network.

10. The apparatus of claim 1, further comprising:
a shear interferometer configured to receive the light and represent a degree of the coherence of the light source through the interference pattern,
wherein when the image measurement unit photographs the interference pattern, the image measurement unit photographs the interference pattern represented on the shear interferometer.

11. A method for measuring a coherence of a light source of a holographic display, the method comprising:
photographing an interference pattern generated by light output from the light source;
obtaining an interference pattern feature information with respect to the interference pattern from an interference pattern image of the interference pattern; and
measuring the coherence of the light source based on the interference pattern feature information.

12. The method of claim 11, wherein
the interference pattern feature information is an average of all brightness values on a straight line parallel to a vertical axis of the interference pattern image when the interference pattern is in a vertical direction.

13. The method of claim 11, wherein
the interference pattern feature information is an average of all brightness values on a straight line parallel to a horizontal axis of the interference pattern image when the interference pattern is in a horizontal direction.

14. The method of claim 11, wherein the measuring the coherence of the light source based on the interference pattern feature information includes:
calculating a contrast of the interference pattern feature information; and
determining a rotation angle of the interference pattern which maximizes the contrast.

15. The method of claim 14, wherein
the contrast is calculated by dividing a difference between a maximum value of the interference pattern feature information and a minimum value of the interference pattern feature information by a sum of the maximum value and the minimum value.

16. The method of claim 14, further comprising
analyzing influence of characteristic information of components of the light source on the coherence by using a neural network based on the rotation angle.

17. The method of claim 16, wherein
the light source includes a spatial filter and a collimator; and
the characteristic information includes at least one of a lens focal distance of the spatial filter, a lens focal distance of the collimator, a size of an aperture of the light source or a pin hole, a diameter of a collimating lens, a diameter of aspheric lens, and a degree of alignment of incident light.

18. The method of claim 11, wherein analyzing influence of characteristic information of components of the light source on the coherence by using a neural network based on the rotation angle includes
performing machine learning by using the neural network based on a training set including the characteristic information of the light source mapped to interference pattern feature information having a high contrast.

19. The method of claim 18, further comprising:
feeding-back an optimal characteristic value for the light source determined by a result of the machine learning through the neural network.

20. An apparatus for measuring coherence for holographic display, the apparatus comprising:
a light source configured to output a plane wave having the coherence;
a camera configured to photograph an interference pattern by the plane wave; and
a processor configured to obtain an interference pattern feature information with respect to the interference pattern from an interference pattern image which is photographed by the camera and measure the coherence of the light source based on the interference pattern feature information.
